(19) United States
(12) Patent Application Publication
(10) Pub. No.: US 2013/0023162 A1
(43) Pub. Date: Jan. 24, 2013

(54) LOW PROFILE ELECTRICAL CONNECTOR HAVING IMPROVED TERMINALS

(71) Applicant: TOD M. HARLAN, Mechanicsburg, PA (US)

(72) Inventor: TOD M. HARLAN, Mechanicsburg, PA (US)

(73) Assignee: HON HAI PRECISION INDUSTRY CO., LTD., New Taipei (TW)

(21) Appl. No.: 13/186,476

(22) Filed: Jul. 20, 2011

(51) Int. Cl. H01R 24/00

(52) U.S. Cl. 439/660

(57) ABSTRACT

An electrical connector includes an insulative housing defining a receiving cavity extending along a longitudinal direction and a plurality of stamped terminals arranged in the insulative housing along the longitudinal direction with each terminal disposed in a transverse plane perpendicularly to the longitudinal direction. Each terminal defines a retaining portion retained in the insulative housing, a contacting portion projecting into the receiving cavity, and a connecting arm connecting the retaining portion with the contacting portion, the contacting portion defines opposite first and second contacting arms upwardly extending toward each other from the connecting arm. The first contacting arm abuts against the second contacting arm when the terminal mating with a counterpart terminal so as to provide a low profile electrical connector.

### BACKGROUND OF THE INVENTION

1. Field of the Invention

The present invention relates generally to an electrical connector, and more particularly to a low profile electrical connector having improved terminals enhancing reliability and durability so as to benefit miniaturization by means of a close-loop contacting portion.

2. Description of the Related Art

U.S. Pat. No. 6,540,561 issued to Masumoto on Apr. 1, 2003 discloses a board to board connector assembly comprising a receptacle connector and a plug connector engaged with the receptacle connector along a first direction for electrical connection therebetween. Each of the receptacle connector and the plug connector includes a plurality of contacts intermatable with each other. The receptacle contact includes a contact portion which forms a protrusion protruding along a second direction perpendicular to the first direction. The plug contact includes a mating portion with a concave portion recessed along the second direction. Therefore, the plug contact and the receptacle contact are securely engaged with each other when the protrusion is received in the concave portion. However, the specific shape, profile, and/or cross-section of either the plug or receptacle contact make it difficult to reduce its height.

Hence, an electrical connector having different contacts design is desired to overcome the aforementioned disadvantage of the prior art.

### SUMMARY OF THE INVENTION

Accordingly, an object of the present invention is to provide a low profile electrical connector having improved terminals configured by a close-loop contacting portion benefit durability and reliability.

In order to achieve the object set forth, an electrical connector includes an insulative housing defining a receiving cavity extending along a longitudinal direction and a plurality of stamped terminals arranged in the insulative housing along the longitudinal direction with each terminal disposed in a transverse plane perpendicularly to the longitudinal direction. Each terminal defines a retaining portion retained in the insulative housing, a contacting portion projecting into the receiving cavity, and a connecting arm connecting the retaining portion with the contacting portion, the contacting portion defines opposite first and second contacting arms upwardly extending toward each other from the connecting arm. The first contacting arm abuts against the second contacting arm when the terminal mating with a counterpart terminal.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector assembly including an electrical connector/a first connector separated from a mating connector/a second connector in accordance with the present invention;

FIG. 2 is similar to FIG. 1, but viewed from other aspect;

FIG. 3 shows the electrical connector assembly in mated state;

FIG. 4 is an exploded view of the electrical connector with respect to FIG. 1;

FIG. 5 is an exploded view of the second connector with respect to FIG. 2; and

FIG. 6 is a cross-section view of the electrical connector assembly taken along line 6-6 of FIG. 3.

### DETAILED DESCRIPTION OF THE INVENTION

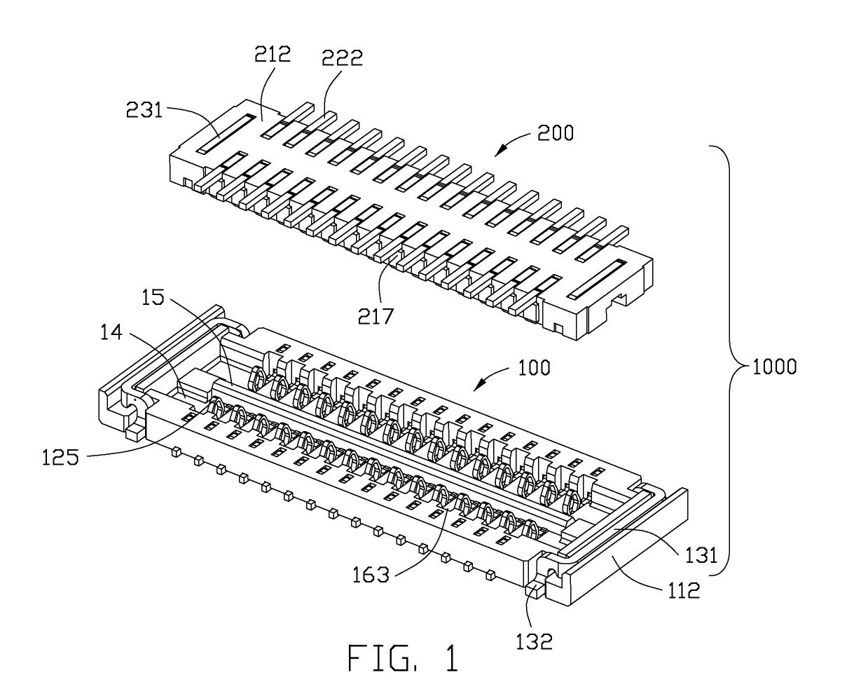

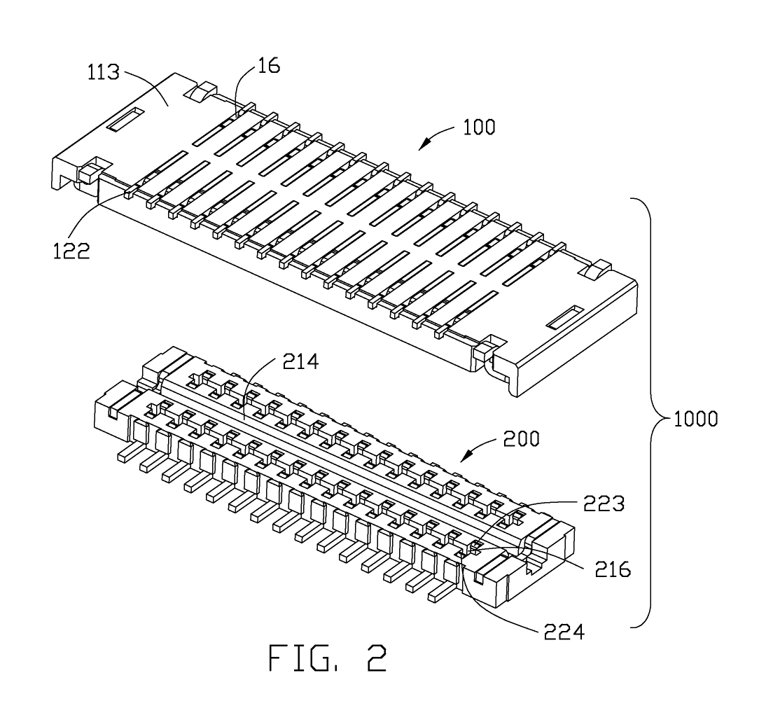

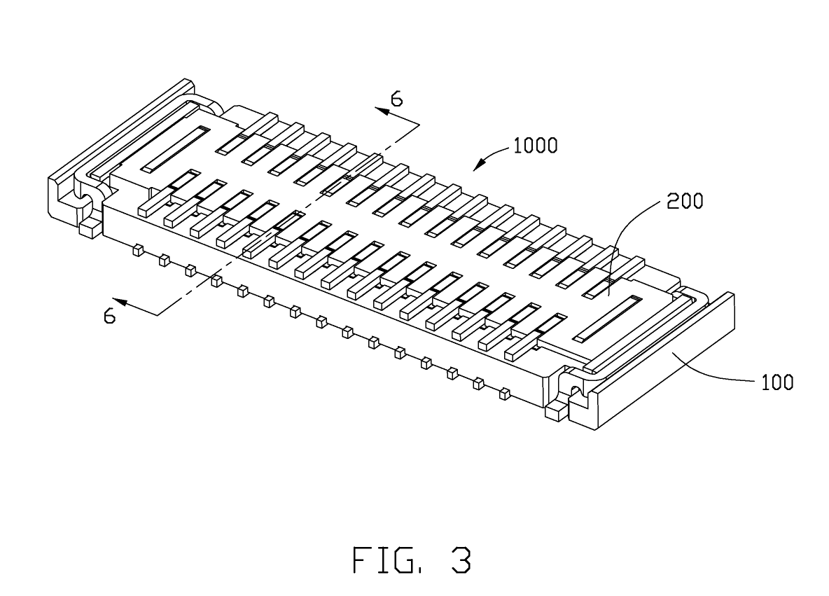

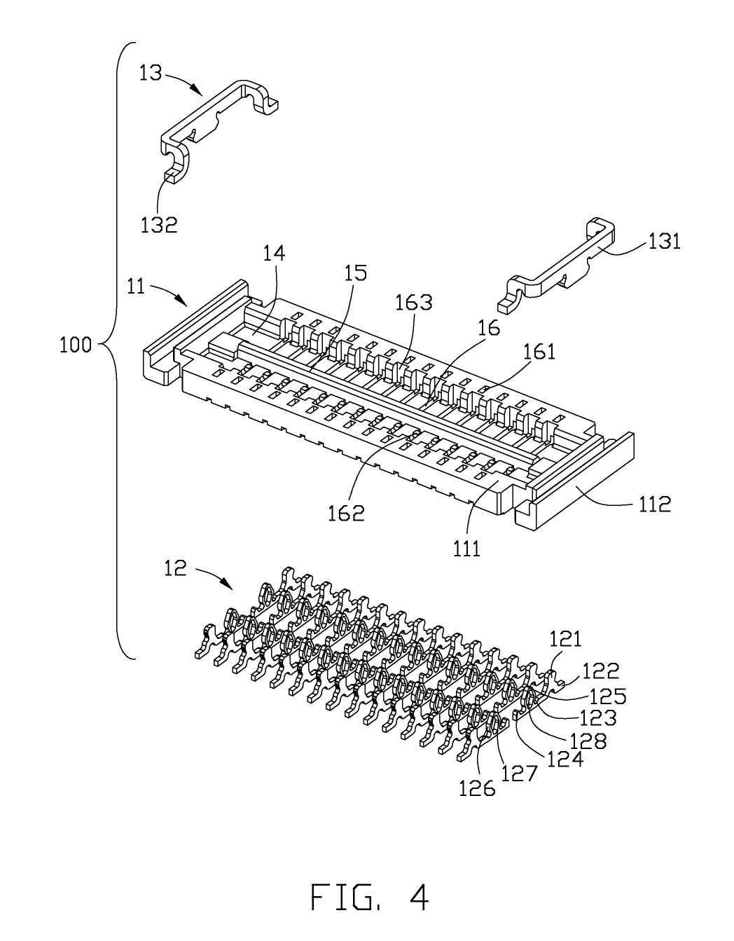

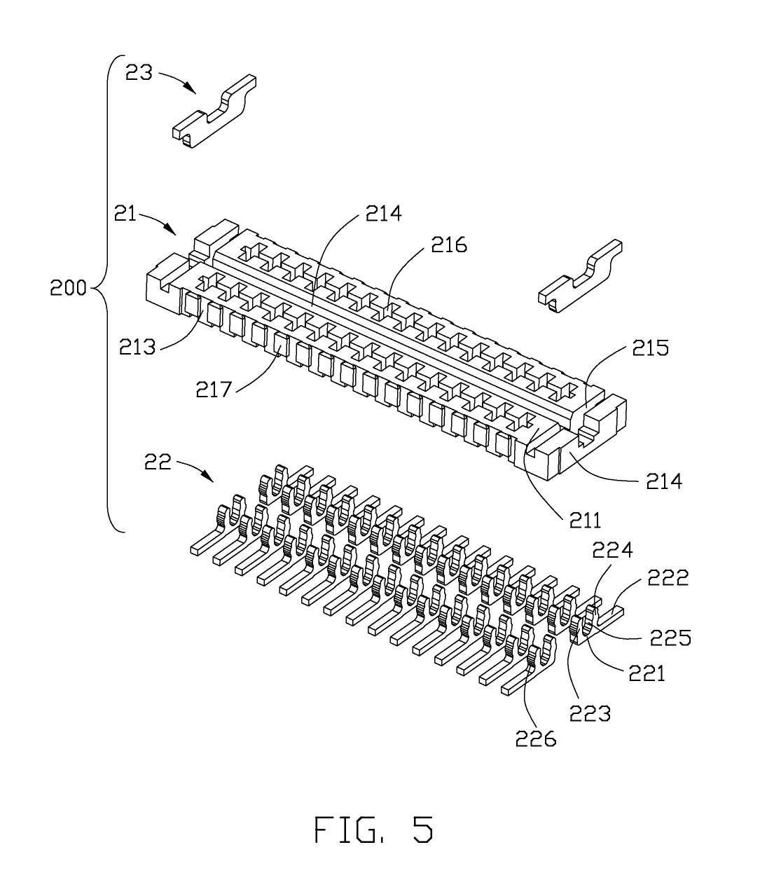

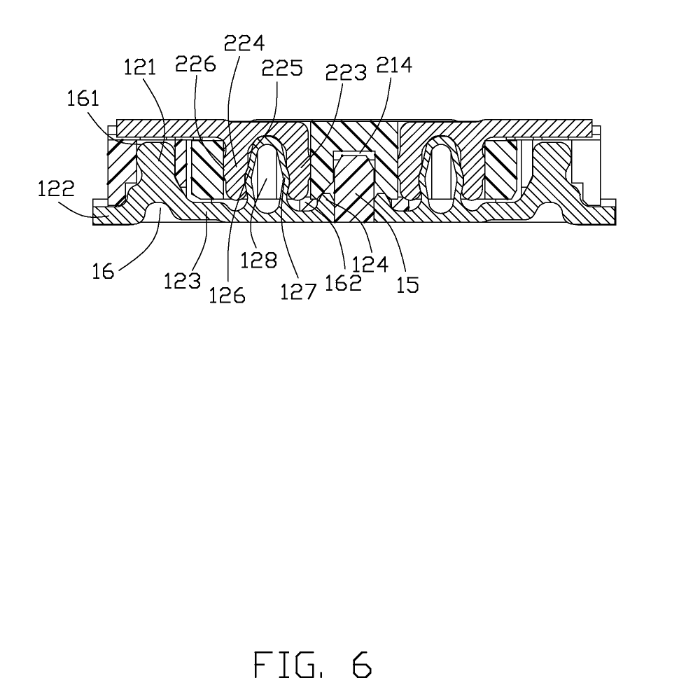

Reference will now be made to the drawing figures to describe a preferred embodiment of the present invention in detail. Referring to FIGS. 1 to 6, an electrical connector assembly 1000 in accordance with the present invention includes an electrical connector/a first connector 100 and a mating connector/second connector 200 both adapted for mounting to corresponding printed circuit boards (not shown) respectively.

Referring to FIGS. 1, 2 and 4, the electrical connector/first connector 100 includes a longitudinal first insulative housing 11 extending along a longitudinal direction, a plurality of first terminals 12 supported by the first insulative housing 11, and two retainers 13 retained on two longitudinal ends of the first insulative housing 11. The first insulative housing 11 includes a pair of sidewalls 111 opposite to each other, a pair of endwalls 112 connecting with said sidewalls 111 and a bottom wall 113 to commonly define a receiving cavity 14. Said bottom wall 113 defines a longitudinal tongue portion 15 protruding upwardly into the receiving cavity 14 and peripherally surrounded by said sidewalls 111 and endwalls 112. Said first insulative housing 11 defines a plurality of first passageways 16 arranged longitudinally to receive said first terminals 12. Each first passageway 16 upwardly extends through the bottom wall 113 to communicate with the receiving cavity 14. The first passageway 16 provides a retaining slot 161 at the sidewall 111 thereof and a guiding slot 163 communicating with the receiving cavity 14 at an inner portion of the sidewall 111. The first passageway 16 further provides a protrusion 162 adjacent to and spaced from the tongue portion 15. The first passageways 16 are arranged in two longitudinal rows and disposed at two opposite sides of the tongue portion 15.

Referring to FIGS. 1, 2, 4 and 6, the first terminal 12 defines a vertical retaining portion 121, a soldering portion 122 extending outwards from one side of the retaining portion 121, a connecting arm 123 extending from another side of the retaining portion 121, and a close-loop contacting portion 125, in this embodiment, upwardly extending from the connecting arm 123. The soldering portion 122 and the connecting arm 123 are disposed at two opposite sides of the retaining portion 121, and the retaining portion 121 and the contacting portion 125 are disposed at a same side of the connecting arm 123. The stamped first terminal 12 is punched from a metal piece, and the retaining portion 121, the soldering portion 122, the connecting arm 123 and the contacting portion 125 are all disposed in a same plane. The connecting arm 123 defines a fixing portion 124 protruding upwardly at a free end thereof, and the close-loop contacting portion 125 is disposed between the retaining portion 121 and the fixing portion 124. The contacting portion 125 defines two spring contacting arms 126, 127 upwardly and oppositely extending from the connecting arm 123, and the first contacting arm 126 interlink with the second contacting arm 127 at an upper portion thereof and define a closed through hole 128 between the first and second contacting arms 126, 127. The first and second contacting arms 126, 127 extend outwardly and then inwardly to interlink with each other. The first terminals 12 are assembled to the first passageways 16 from the bottom wall 113 thereof, the retaining portion 121 is received in the retaining slot 161, and the fixing portion 124 is sandwiched between the protrusion 162 and the tongue portion 15, the contacting portion 125 projects into the receiving cavity 14, and the soldering portion 122 extends out of the first insulative housing 11. The retaining portion 121 engages with the retaining slot 161, synchronously the fixing portion 124 is clipped between the protrusion 162 and the tongue portion 15 to retain the first terminal 12 to the first insulative housing 11 securely. The plurality of first terminals 12 are arranged in the first insulative housing along the longitudinal direction, and each first terminal 12 is disposed in a transverse plane perpendicular to the longitudinal direction so as to benefit miniaturization.

The two retainers 13 each defines a base portion 131 and a pair of soldering pads 132 extending from two ends of said base portion 131. The two retainers 13 are downwardly assembled to the corresponding endwalls 112 respectively, the base portion 131 is retained on the endwall 112 and the soldering pads 132 extend out of first insulative housing 11.

Referring to FIGS. 1, 2 and 5, the mating connector/second connector 200 defines a longitudinal second insulative housing 21, a plurality of second terminals 22 supported by the second insulative housing 21, and two retainers 23 retained on two longitudinal ends of the second insulative housing 21. The second insulative housing 21 defines a mating face 211, a mounting face 212 opposite to the mating face 211, a pair of opposite side faces 213 connecting with the mating face 211 and the mounting face 212, and a pair of opposite end faces 214 connecting with the mating face 211 and the side faces 213. The second insulative housing 21 defines a longitudinal locking slot 214 recessed downwardly from the mating face 211 in the middle portion thereof and a pair of receiving slots 215 disposed at two longitudinal ends of the mating face 211. A plurality of second passageways 216 are arranged longitudinally at two sides of the locking slot 214 and disposed between the two receiving slots 215, and each second passageway 216 runs through the mating face 211 and the mounting face 212. The second insulative housing 21 further defines a plurality of guiding portions 217 protruding outwardly from each side face 213 thereof.

Referring to FIGS. 1, 2, 4 and 6, the F-shaped second terminal 22 defines a connecting portion 221, a soldering portion 222 horizontally extending away from the connecting portion 221, and a pair of retaining arms 223, 224 oppositely and upwardly extending from the connecting portion 221. The first and second retaining arms 223, 224 are spaced from each other and provide a receiving room 225 therebetween. Each stamped second terminal 22 are punched from a metal sheet, and the connecting portion 221, the soldering portion 222 and the first and second retaining arms 223, 224 are all disposed in a same plane. The second terminals 22 are upwardly assembled into the second passageways 216 from the mounting face 212 thereof, the first and second retaining arms 223, 224 are inwardly pushed and deflected to retain in the second passageway 216, and the soldering portion 222 extends out of the second insulative housing 21. The barbs 226 disposed at the first and second retaining arms 223, 224 engage with inner faces of the second passageway 216 to enhance the retaining force between the second terminal 22 and the second insulative housing 21. The two retainers 23 are downwardly assembled into the corresponding receiving slots 215 and each provides a soldering face 231 exposed on two longitudinal ends of the mounting face 212. The two retainers 23 may enhance the rigidity of the second insulative housing 21, and the soldering face 231 may improve the connection between the second connector 200 and the printed circuit board which is adapted for the second connector mounting to.

Referring to FIGS. 1, 2, 3 and 6, when the electrical connector/first connector 100 mates with the mating connector/second connector 200 along a mating direction, the guiding portions 217 align with the guiding slots 163 and downwardly move along the guiding slots 163 to guide the second insulative housing 21 entering into the receiving cavity 14, the contacting portion 125 projects into the receiving room 225 to contact with the first and second retaining arms 223, 224, thus the first and second contacting arms 126, 127 are sandwiched between the first and second retaining arms 223, 224 and inwardly pushed and deflected to abut against each other. The first and second contacting arms 126, 127 abutting against each other may improve the rigidity of the first terminal 12 and make the first terminal 12 suitable for an electrical connector featured in low-profile configuration. Because the unique configuration of the first terminals 12 and the second terminals 22, the first connector 100 and the second connector 200 are reliably engaged with each other. The tongue portion 15 is locked in the locking slot 214 to improve the retaining fore between the first connector 100 and the second connector.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing defining a receiving cavity extending along a longitudinal direction; and
a plurality of stamped terminals arranged in the insulative housing along the longitudinal direction with each terminal disposed in a transverse plane perpendicularly to the longitudinal direction, each terminal defining a retaining portion engaged with the insulative housing, a contacting portion projecting into the receiving cavity, and a connecting arm connecting the retaining portion with the contacting portion;
wherein the contacting portion defines opposite first and second contacting arms upwardly extending toward each other from the connecting arm, and the first contacting arm abuts against the second contacting arm at an upper portion thereof when the terminal mated with a counterpart terminal.

2. The electrical connector as described in claim 1, wherein the first and second contacting arms interlink with each other and define a closed through hole between the first and second contacting arms.

3. The electrical connector as described in claim 1, wherein the retaining portion and the contacting portion are disposed at a same side of the connecting arm.

4. The electrical connector as described in claim 3, wherein the connecting arm defines a fixing portion protruding upwardly at a free end thereof, and the contacting portion is disposed between the retaining portion and the fixing portion.

5. The electrical connector as described in claim 4, wherein each terminal defines a soldering portion extending from the retaining portion, and the soldering portion and the connecting arm are disposed at two opposite sides of the retaining portion.

6. The electrical connector as described in claim 4, wherein the insulative housing defines a pair of sidewalls and a pair of endwalls connecting with the sidewalls to surround the receiving cavity, the retaining portion of each terminal is retained in the sidewall.

7. The electrical connector as described in claim 6, wherein the insulative housing defines a tongue portion disposed in the receiving cavity and a plurality of passageways arranged longitudinally to receive the terminals, each passageway provides a protrusion spaced from the tongue portion, and the fixing portion is sandwiched between the protrusion and the tongue portion.

8. The electrical connector as described in claim 7, wherein each passageway provides a guiding slot communicating with the receiving cavity at an inner portion of the sidewall.

9. The electrical connector as described in claim 8, further defining a pair of retainers respectively retained in the endwalls.

10. The electrical connector as described in claim 1, wherein the retaining portion, the contacting portion and the connecting arm are all disposed in a same plane.

11. An electrical connector assembly comprising:
a first connector comprising a first insulative housing defining a receiving cavity extending along a longitudinal direction, a plurality of stamped first terminals arranged in the insulative housing along the longitudinal direction and each defining a retaining portion retained in the insulative housing and a contacting portion projecting into the receiving cavity, the contacting portion defining opposite first and second contacting arms upwardly extending toward each other; and
a second connector comprising a second insulative housing extending along the longitudinal direction and a plurality of stamped second terminals retained in the second insulative housing by a first and a second retaining arm engaging with the second insulative housing, the first and second retaining arms spaced from each other and providing a receiving room disposed therebetween;
wherein the contacting portion enters into the receiving room to contact with the first and second retaining arms with the first and second contacting arms inwardly pushed to abut against each other at an upper portion when the first terminal mating with the second terminal.

12. The electrical connector assembly as described in claim 11, wherein the first contacting arm interlink with the second contacting arm and define a closed through hole between the first and second contacting arms.

13. The electrical connector assembly as described in claim 12, wherein each first terminal defines a connecting arm extending from the retaining portion, the first and second contacting arms upwardly extend from the connecting arm.

14. The electrical connector assembly as described in claim 11, wherein the first and second retaining arms are inwardly pushed to retain in the second insulative housing.

15. The electrical connector assembly as described in claim 11, wherein the first insulative housing defines a guiding slot communicating with the receiving cavity at an inner portion thereof, and the second insulative housing defines a guiding portion protruding outwardly for cooperating with the guiding slot.

16. An electrical connector assembly comprising:
a first connector including:
a first insulative housing extending along a lengthwise direction and defining a plurality of passageways along said lengthwise direction under condition that each of said passageways extends in a transverse direction perpendicular to said lengthwise direction, respectively;
a plurality of first contacts disposed in the corresponding first passageways, respectively, each of said first contacts formed and directly stamped from metal sheet under condition that each of said first contacts defines a thickness direction along said lengthwise direction, each of said first contacts defining a U-shaped contact section including two opposite retaining arms;
a second connector mated with the first connector and including:
a second insulative housing defining along said lengthwise direction a plurality of second passageways, respectively, under condition that each of said second passageways extends in the transverse direction;
a plurality of second contacts disposed in the corresponding second passageways and mated with the corresponding first contacts, respectively, each of said second contacts formed and directly stamped from sheet metal under condition that each of said second contacts defines a thickness direction along said lengthwise direction; wherein
each of said second contacts defines a pair of opposite contacting arms respectively engaged with and deflected by the opposite retaining arms of the corresponding U-shaped contact section in the transverse direction.

17. The electrical connector assembly as claimed in claim 16, wherein the contacting arms commonly form a loop structure.

18. The electrical connector assembly as claimed in claim 16, wherein a pair of retention structures are located by two sides of the opposite contacting arms in the transverse direction.

19. The electrical connector assembly as claim 16, wherein the retaining arms of the first contact define barbs on outer edges for retaining the first contact in the corresponding passageway and further define specific configuration on inner edges for compliance with the contacting arms of the second contact.

20. The electrical connector assembly as claimed in claim 16, wherein the retaining arms of the first contact define barbed structures for engagement within the passageway in the transverse direction to retain the first contact in the housing.
